(19) United States
(12) Patent Application Publication
(10) Pub. No.: US 2015/0355819 A1
(43) Pub. Date: Dec. 10, 2015

(54) INFORMATION PROCESSING APPARATUS, INPUT METHOD, AND RECORDING MEDIUM

(71) Applicant: CANON KABUSHIKI KAISHA, Tokyo (JP)

(72) Inventors: Yoko Saino, Tokyo (JP); Shinya Takeichi, Kawasaki-shi (JP)

(21) Appl. No.: 14/724,038

(22) Filed: May 28, 2015

(30) Foreign Application Priority Data
Jun. 6, 2014 (JP) 2014-117872

(51) Int. Cl. G06F 3/0484; G06F 3/01

(52) U.S. Cl. CPC G06F 3/04842; G06F 3/04847; G06F 3/017

(57) ABSTRACT

The information processing apparatus identifies whether a state of a pointer which is close to the display screen is in a hover state or in a touch state. According to the duration pointed by the pointer which is in the hover state, the information processing apparatus sets the priority to each item. When the state of the pointer changes from the hover state to the touch state, the information processing apparatus specifies the item touched by the pointer from the plurality of items according to the touch position and the priority.

### BACKGROUND OF THE INVENTION

1. Field of the Invention

The present disclosure relates to a technology for inputting to the information processing apparatus through a graphic user interface (GUI).

2. Description of the Related Art

An information processing apparatus employing a touch panel, in which a display device and a locator device are combined to form an input device, displays an item representing the GUI (GUI item) on a display screen. The GUI item is related to a predetermined process. When the GUI item is touch-operated by a finger or a stylus pen, the touch panel transmits data for executing the processing related to the GUI item to the information processing apparatus. According to the data received from the input device, the information processing apparatus executes the processing related to the GUI item.

The information processing apparatus employing the touch panel as the input device includes car navigation system, smart phones, tablet terminals and the like. Using the touch panel as the input device, more intuitive input operation can be realized as compared with the input operation using a pointing device such as a mouse. In the car navigation system or smart phones, a plurality of small GUI items are aligned and displayed on a small display screen. Thereby, when the GUI item is touch-operated, a user may wrongly operate the GUI item against the user's intention. Japanese Patent Application Laid-open No. 2009-116583 discloses an invention which prevents wrong operation of the GUI item. In particular, when a pointer such as a finger or a stylus pen comes close to a touch panel display screen, according to the distance, the GUI item is enlarged and displayed so that the item to be touched is explicitly shown. It is noted that, in this specification, a state in which the finger or the stylus pen does not touch but is in proximity to the touch panel display screen is defined “hover state”.

When the GUI item is enlarged and displayed according to the position of the pointer such as the finger, the stylus pen and the like in the hover state, as the pointer moves, layout of the display screen is often changed. As a result, the position displaying the GUI item moves so that the user may find it difficult to determine where to touch. Thereby, a technology which enhances operability of the touch operation of the plurality of GUI items aligned and displayed while keeping the layout on the display screen is desired.

### SUMMARY OF THE INVENTION

The information processing apparatus according to the present disclosure comprises a display control unit configured to display a plurality of items on a display screen; an identifying unit configured to identify a state of a pointer which is close to the display screen, whether the pointer is in a hover state or in a touch state; a determining unit configured to determine priority of each of the plurality of items displayed on the display screen according to a duration pointed by the pointer which is in the hover state to the display screen; a specifying unit configured to specify the item touched by the pointer from the plurality of items displayed on the display screen using the priority determined by the determining unit in a case where the state of the pointer identified by the identifying unit is changed from the hover state to the touch state.

Further features of the present invention will become apparent from the following description of exemplary embodiments (with reference to the attached drawings).

### BRIEF DESCRIPTION OF THE DRAWINGS

FIG. 1 is a hardware configuration diagram of the information processing apparatus.

FIG. 2 is a functional block diagram representing functions formed in the information processing apparatus.

FIG. 3 is a diagram explaining track of the coordinates of the pointer.

FIG. 4 is a diagram explaining touch area touched by the pointer and the ratio of the touch area.

FIG. 5 is a diagram illustrating a management table.

FIG. 6 is a flowchart representing processing for executing processing related to the GUI item.

FIG. 7 is a flowchart representing processing for determining the priority of the GUI item.

FIG. 8 is a flowchart representing processing for selecting the GUI item.

FIG. 9 is a functional block diagram representing a function which is formed in the information processing apparatus.

FIG. 10 is a flowchart representing processing for determining the priority of the GUI item.

FIG. 11 is a flowchart representing processing for determining the priority of the GUI item.

FIG. 12 is a flowchart representing processing for selecting the GUI item.

FIGS. 13A and 13B are diagrams explaining processing for selecting the GUI item.

### DESCRIPTION OF THE EMBODIMENTS

In the following, embodiments are described in detail with reference to the accompanying drawings. It is noted that the components described in the present embodiment are simply the illustration and the scope of the present invention is not limited to the components.

### First Embodiment

(Configuration)

FIG. 1 is a hardware configuration diagram of an information processing apparatus according to a present embodiment. The information processing apparatus 100 comprises a touch panel 102 as an input device. In addition, the information processing apparatus 100 comprises a controller 101 and a large capacity storing unit 103. The controller 101 comprises a central processing unit (CPU) 104, a read only memory (ROM) 105, and a random access memory (RAM) 106. Such information processing apparatus 100 can be realized by an apparatus comprising the touch panel 102 as the input device, such as the car navigation system, smart phones, tablet terminals, and the like.

The controller 101 controls the entire operation of the information processing apparatus 100. Thus, the CPU 104 reads computer program from the ROM 105 and the large capacity storing unit 103 and executes the computer program using the RAM 106 as a work area. The ROM 105 and the large capacity storing unit 103 store the computer program and data required when executing the computer program. The RAM 106 is used as the work area so that it temporarily stores data etc. used for the processing. For example, data, the contents of which are rewritten according to the processing, is stored in the RAM 106. A management table, which will be described later, is one of the examples. Hard disk, solid state drive (SSD), and the like can be used as the large capacity storing unit 103.

The touch panel 102 is a user interface combining the display device and the locator device. By the control of the controller 101, a GUI screen, including one or more GUI items related to the processing is displayed on the display screen of the display device. The GUI item includes, for example, buttons and text field which form the display of the application. The touch panel 102 is touch-operated by the pointer such as the user's finger, the stylus pen, and the like. The locator device, comprising a touch sensor for detecting a touch by the pointer, transmits data representing the detection result (touch data) to the controller 101. The locator device periodically detects the touch operation and transmits the touch data to the controller 101.

It is noted that the touch panel 102 (locator device) detects a state in which the pointer is actually touching the display screen. In addition, the touch panel 102 detects the hover state in which the pointer is close to the screen display. When the touch panel is an electrostatic capacitance type touch panel, the locator device can identify and detect whether the pointer is in the hover state or is touching the display screen according to the magnitude of the electrostatic capacitance between the pointer and the touch panel 102. In addition to detecting the touch operation in an electrostatic capacitance manner, the touch operation may be detected by a combination of a plurality of sensors. In either case, i.e., regardless of being in the hover state or being in touch of the display screen, the touch panel 102 transmits the touch data representing the detection result to the controller 101. The method to detect the hover state, however, is not limited to the electrostatic capacitance manner. A system in which the pointer's state is identified to be in the touch state or in the hover state and is detected based on the three-dimensional position information is also available. The three-dimensional position information is the information of a space where the operation is performed, which is obtained using a reflection pattern of an infrared light or stereo camera.

Based on the touch data received from the touch panel 102, the controller 101 can specify a position of the pointer in the hover state or a touch position on the display screen touched by the pointer. The controller 101 stores the display position and a size of the GUI item included in the GUI screen in the RAM 106. If the specified touch position is within a display area of the GUI item, the controller 101 recognizes that the GUI item is touch-operated. Then, the controller 101 executes the processing related to the GUI item. The display area of the GUI item is specified according to the display position and the size. It is noted that the touch operation may be recognized at the time at which an end of the touch (i.e., release from the touch position) is confirmed before a lapse of a predetermined time after touching the touch position. The operation is generally called “tap”. Each of the components as mentioned is not necessarily limited to that connected in the information processing apparatus 100. A part of the components may be an external device which is connected via various interfaces.

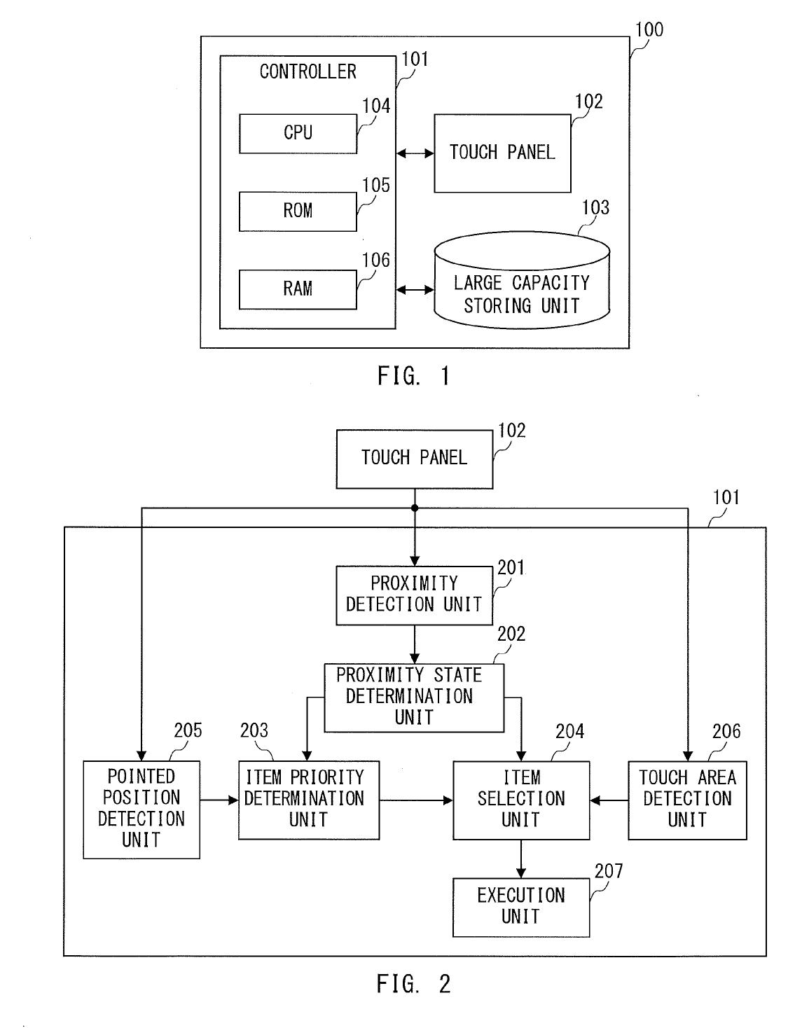

FIG. 2 represents a function which is realized by the information processing apparatus 100 (controller 101) when the CPU 104 executes the computer program. The controller 101 includes a proximity detection unit 201, a proximity state determination unit 202, an item priority determination unit 203, an item selection unit 204, a pointed position detection unit 205, a touch area detection unit 206, and an execution unit 207.

Based on the touch data received from the touch panel 102, the proximity detection unit 201 detects a degree of proximity between the pointer and the display screen of the touch panel 102. The degree of proximity represents, for example, a distance between the pointer and the display screen of the touch panel 102. In case of the electrostatic capacitance touch panel 102, the proximity detection unit 201 can calculate the degree of proximity based on the electrostatic capacitance between the pointer and the touch panel 102. For example, where a magnitude of the electrostatic capacitance exceeds a predetermined threshold value, the proximity detection unit 201 assumes that the distance between the pointer and the display screen of the touch panel 102 is “0”. The proximity detection unit 201 periodically receives the touch data from the touch panel 102. Every time the degree of proximity detection unit 201 receives the data, the proximity detection unit 201 calculates the degree of proximity.

Based on the degree of proximity calculated by the proximity detection unit 201, the proximity state determination unit 202 determines how close the pointer is. That is, the proximity state determination unit 202 determines whether the pointer is touching the display screen of the touch panel 102 or it is in the hover state. For example, if the distance between the pointer and the display screen of the touch panel 102 represented by the degree of proximity is “0”, the proximity state determination unit 202 determines that the pointer is touching the display screen (touch state). If the distance represented by the proximity is greater than and less than a predetermined distance, the proximity state determination unit 202 determines that the pointer is in the hover state. If the distance represented by the degree of proximity is greater than a predetermined distance, the proximity state determination unit 202 determines that the pointer is not close to the display screen. The proximate state determination unit 202 transmits the determination result to the item priority determination unit 203 and the item selection unit 204.

Based on the touch data received from the touch panel 102, the pointed position detection unit 205 detects a position on the GUI screen (coordinate) pointed by the pointer. Thus, the pointed position detection unit 205 calculates the coordinate on the display screen of the touch panel 102 pointed by the pointer based on the touch data. Further, the pointed position detection unit 205 converts the coordinate on the display screen calculated to the coordinate on the GUI screen being displayed. Through the above mentioned manner, the pointed position detection unit 205 detects the position on the GUI screen pointed by the pointer. The pointed position detection unit 205 outputs the position information representing the position on the GUI screen (coordinate) detected.

Based on the touch data received from the touch panel 102, the touch area detection unit 206 detects the area on the GUI screen to be touched by the pointer. Thus, based on the touch data, the touch area detection unit 206 calculates the touch area on the display screen. The touch area is a set of the coordinate points included, for example, in the area touched by the pointer. Further, the touch area detection unit 206 converts the touch area on the display screen calculated for the area on the GUI screen being displayed. Through the above mentioned manner, the touch area detection unit 206 detects the area on the GUI screen to be touched by the pointer. The touch area detection unit 206 outputs the touch area information representing the area on the GUI screen detected.

If it is determined by the proximity state determination unit 202 that the pointer is in the hover state, the item priority determination unit 203 determines the priority of the GUI item based on the position information obtained from the pointed position detection unit 205. The item priority determination unit 203 sets the priority to the GUI item included in the GUI screen, for example, in the order of duration during which the pointer is in the hover state to point. In particular, the item priority determination unit 203 determines the GUI items positioned at the coordinate represented by the position information obtained from the pointed position detection unit 205 and counts the duration during which the GUI item is pointed. The count value is managed as a hover time for every GUI item by the management table as described later. The item priority determination unit 203 determines the priority for every GUI item according to the hover time.

Now, description is given with regard to the priority in a case where three GUI items, GUI item A, GUI item B, and GUI item C are displayed within the GUI screen. When the ratio of the hover time of each GUI item A, B and C is 6:3:1, the item priority determination unit 203 determines the priority in the order of the GUI item A, the GUI item B, and the GUI item C. According to the ratio of the hover time, the priority is set to each GUI item as follows:

GUI item A: “0.6”

GUI item B: “0.3” and

GUI item C: “0.1”

If it is determined by the proximity state determination unit 202 that the pointer is in the touch state, the item selection unit 204 selects the GUI item based on the touch area information obtained from the touch area detection unit 206 and the priority determined by the item priority determination unit 203. The item selection unit 204 determines the GUI item displayed in the area to be touched by the pointer represented by the touch area information. If a plurality of the GUI items are displayed in the touch area, the item selection unit 204 calculates the ratio of the size (area) of the touch area included in the display area of each GUI item. Based on the ratio calculated and the priority, the item selection unit 204 selects one from the plurality of the GUI items to which the processing is executed.

The execution unit 207 executes the processing related to the GUI item selected in the item selection unit 204. In this embodiment, the information processing apparatus 100 and the touch panel 102 (input device) are integrated. The information processing apparatus 100 executes the processing related to the GUI item touched by the pointer. Thereby, the execution unit 207 is formed in the controller 101.

FIG. 3 is a diagram explaining a position pointed by the pointer detected by the pointed position detection unit 205. In FIG. 3, five GUI items (button A to E) are included in the GUI screen. In FIG. 3, the pointer points the buttons A, B, and C in the hover state and does not point the buttons E and D. The item priority determination unit 203 counts up the count value of the GUI item which is at the position represented by the position information. In the example of FIG. 3, the count value of the buttons A, B, and C is “600”, “300”, and “100” respectively. The count value of the buttons D and E is “0”. In this case, the priority of each button is as follows:

button A: “600/1000=0.6”,

button B: “300/1000=0.3”,

button C: “100/1000=0.1,

buttons D, E: 0

Through the above mentioned manner, the priority of each GUI item is determined. The GUI item which is pointed in the hover state by the pointer for a longer time is more highly weighted and prioritized

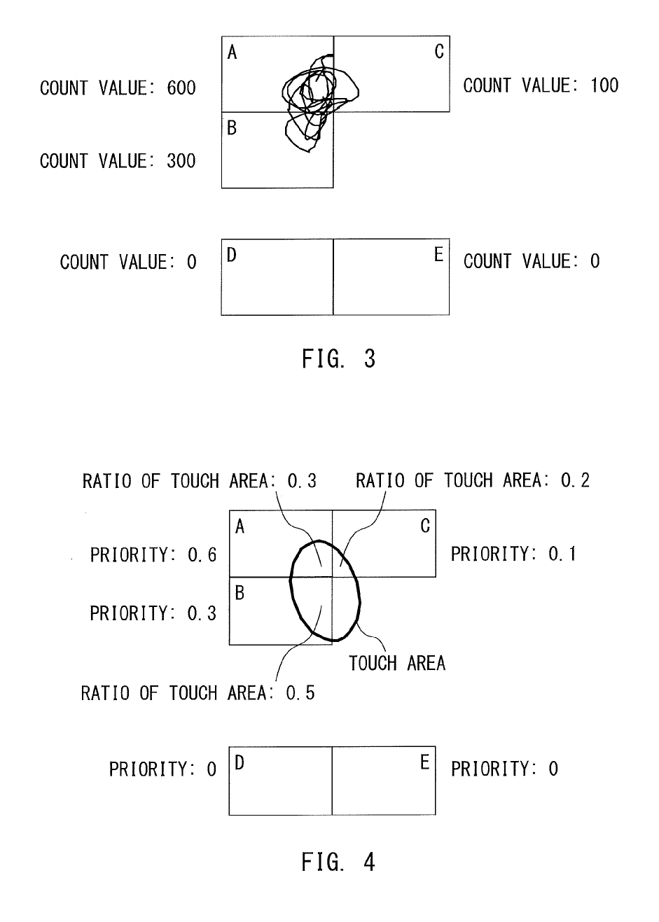

FIG. 4 is a diagram explaining touch area touched by the pointer and the ratio of the touch area. Similar to FIG. 3, five GUI items (button A to E) are included in the GUI screen. The touch area detected by the touch area detection unit 206 is represented by an oval. The touch area overlaps the display area of the buttons A, B, and C. The ratio of the touch area of each button is “0.3”, “0.5”, and “0.2” respectively. The ratio of the touch area is obtained as follows.

First, the item selection unit 204 determines the GUI item touched by the pointer based on the coordinate included in the touch area. Then, the item selection unit 204 calculates the number of coordinates included in the touch area. Then, the ratio of the touch area to the display area of each GUI item is calculated, which is the ratio of the touch area. The ratio of the touch area represents the size of the display area of the GUI item included in the touch area.

Based on the ratio of the touch area and the priority of each GUI item, the item selection unit 204 selects the GUI item. For example, the item selection unit 204 selects the GUI item having max product of the ratio of the touch area and the priority. In case of FIG. 4, the product of each GUI item is obtained as follows. button A: 0.6*0.3=0.18

button B: 0.3*0.5=0.15

button C: 0.1*0.2=0.02

buttons D, E: 0

The product of button A is the max so that the item selection unit 204 selects the button A.

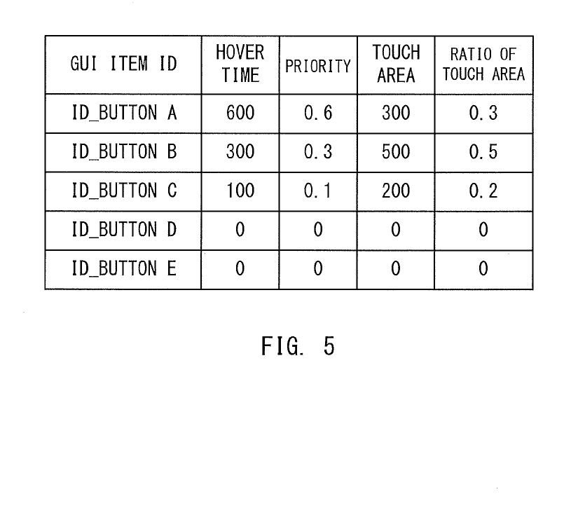

FIG. 5 is a diagram illustrating the management table. In the management table, the GUI item is identified by “GUI item ID” to manage “hover time”, “priority”, “touch area”, and “ratio of touch area” of each GUI item. In the example of FIG. 5, the management table manages the buttons A to E shown in FIGS. 3 and 4.

When the coordinate included in the position information obtained from the pointed position detection unit 205 is included in the display area of the GUI item, the item priority determination unit 203 counts up the count value of the hover time of the GUI item. The priority is calculated based on the count value. Every time the coordinate in the hover state is detected, the count value is counted up and the priority is calculated. The item priority determination unit 203 stores the hover time and the priority in the management table. The item selection unit 204 calculates the touch area and the ratio of the touch area based on the coordinate included in the touch area information obtained from the touch area detection unit 206 and the display area of the GUI item and stores the result in the management table.

(Processing)

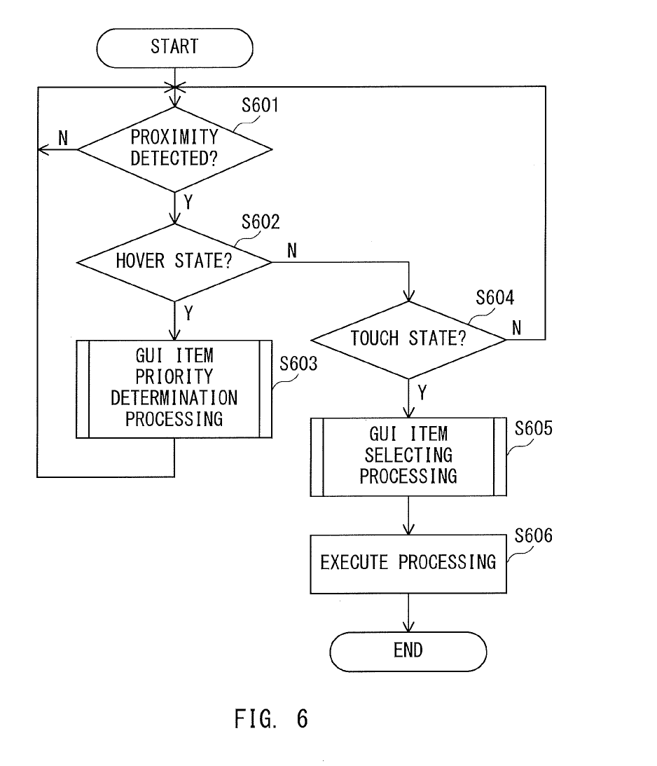

FIG. 6 is a flowchart representing processing, executed by the information processing apparatus 100 having such configuration, related to the GUI item pointed by the pointer. The touch panel 102 periodically detects the touch operation and inputs the touch data to the controller 101.

The proximity state determination unit 202 determines whether the degree of proximity is detected by the proximity detection unit 201 or not (S601). If it is determined that the degree of proximity is detected (S601: Y), the proximity state determination unit 202 determines whether or not the pointer is in the hover state based on the degree of proximity (S602). If it is determined that the pointer is in the hover state (S602: Y), the item priority determination unit 203 obtains a notification from the proximity state determination unit 202 that the pointer is in the hover state and executes processing for determining the priority of the GUI item (S603). The detail of the processing for determining the priority of the GUI item is described later.

If it is determined that the pointer is not in the hover state (S602: N), the proximity state determination unit 202 determines whether the pointer is touching the display screen of the touch panel 102 (touch state) (S604). If it is determined that the pointer is in the touch state (S604: Y), the item selection unit 204 obtains a notification from the proximity state determination unit 202 that the pointer is in the touch state and executes processing for selecting the GUI item (S605). The detail of the processing for selecting the GUI item is described later.

When the GUI item is selected by the item selection unit 204, the execution unit 207 obtains the information of the GUI item selected by the item selection unit 204. Based on the information of the GUI item obtained, the execution unit 207 executes processing related to the GUI item (S606). Through the above mentioned manner, the processing relating to the GUI item is performed. It is noted that, if it is determined that the pointer is not in the touch state (S604: N), the controller 101 returns to the processing of S601 for the processing by the next touch data.

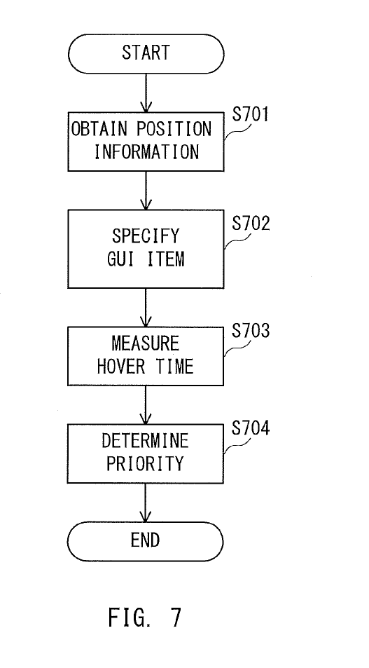

FIG. 7 is a flowchart representing processing of S603 for determining the priority of the GUI item.

The item priority determination unit 203 obtains position information from the pointed position detection unit 205 (S701). Based on the position information obtained, the item priority determination unit 203 specifies the GUI item pointed by the pointer (S702). The item priority determination unit 203 specifies the GUI item which includes the position pointed in the hover state by the pointer represented by the position information in the display area determined by the display position and the size.

The item priority determination unit 203 measures the hover time to the specified GUI item, and stores the result in the management table (S703). The item priority determination unit 203 determines the priority based on the hover time and stores the priority determined in the management table (S704). Through the above processing, the “hover time” and the “priority” of the management table shown in FIG. 5 are set.

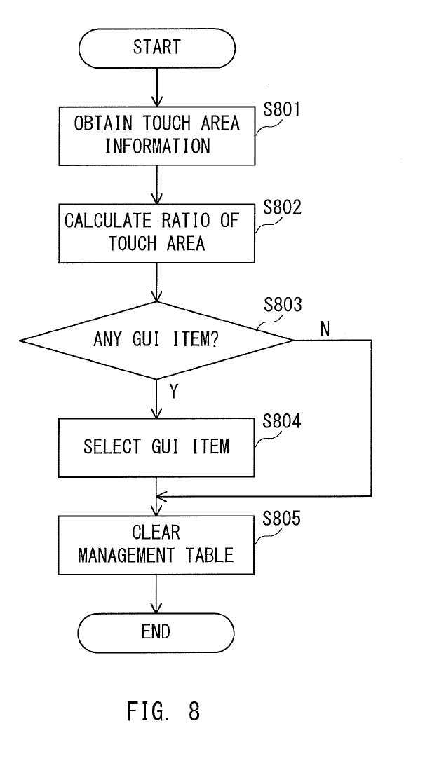

FIG. 8 is a flowchart representing processing of S605 in FIG. 6 for selecting the GUI item.

The item selection unit 204 obtains the touch area information from the touch area detection unit 206 (S801). Based on the touch area information, the item selection unit 204 calculates the ratio of the touch area (S802). For example, the item selection unit 204 specifies the GUI item based on the coordinate in the touch area represented by the touch area information, and counts up the value of the touch area in the management table of the specified GUI item. The item selection unit 204 performs the processing to all the coordinates in the touch area, calculates the ratio of the touch area based on the value of the touch area and stores the calculated result in the management table.

The item selection unit 204 confirms the management table and determines whether the GUI item having the priority set is in the touch area or not (S803). For example, in the management table in FIG. 5, the priority is set to the buttons A, B, and C, which have the ratio of the touch area larger than “0”. In this case, the item selection unit 204 determines that the GUI item having the priority set is in the touch area.

If it is determined that the GUI item having the priority set is in the touch area (S803: Y), the item selection unit 204 selects the GUI item based on the ratio of the touch area and the priority (S804). In the management table in FIG. 5, the button A, having the max product of the ratio of the touch area and the priority, is selected. After selecting the GUI item, or if the GUI item having the priority set is not in the touch area (S803: N), the item selection unit 204 clears all contents in the management table including the priority and ends the processing (S805)

In the processing of S702 in FIG. 7, the item priority determination unit 203 specifies the GUI item which measures the hover time based on the position information. In the processing of S802 in FIG. 8, the item selection unit 204 specifies the GUI item which counts the touch area based on the touch area information. In these processing, GUI item is specified based on the coordinate of the position pointed by the pointer. Instead of the detected coordinate, corrected coordinate may be used. For example, a gap may be caused between a position at which the user intends to point by his finger and a position to actually be detected by the touch panel 102 according to the user's visual line angle to the touch panel 102. In this case, based on the corrected coordinates, corrected by adding correction value in which the gap is taken into account, to the coordinate of the position detected by the touch panel 102, the GUI item may be specified by the item priority determination unit 203 and the item selection unit 204.

The priority stored in the management table is determined according to the ratio of the hover time. The priority may also be set by adding elements other than the ratio of the hover time. For example, the user's selection frequency and the latest order of selection may be added to the hover time to set the priority of the GUI item. That is, the history of past selection of the GUI item is stored in the RAM 106 and the item priority determination unit 203 may set the priority considering the history.

Through the above mentioned manner, the information processing apparatus 100 of the present embodiment sets the priority to the GUI item based on the hover time, sets the ratio of the touch area based on the position actually touched and selects the GUI item based on the priority and the ratio of the touch area. Thereby, the information processing apparatus 100 can reduce the probability of wrong operation of the GUI item by the touch operation from the hover state. Further, the layout of the GUI item included in the GUI screen displayed on the display screen at this time is maintained, which improves the operability of the touch operation of the GUI item.

### Second Embodiment

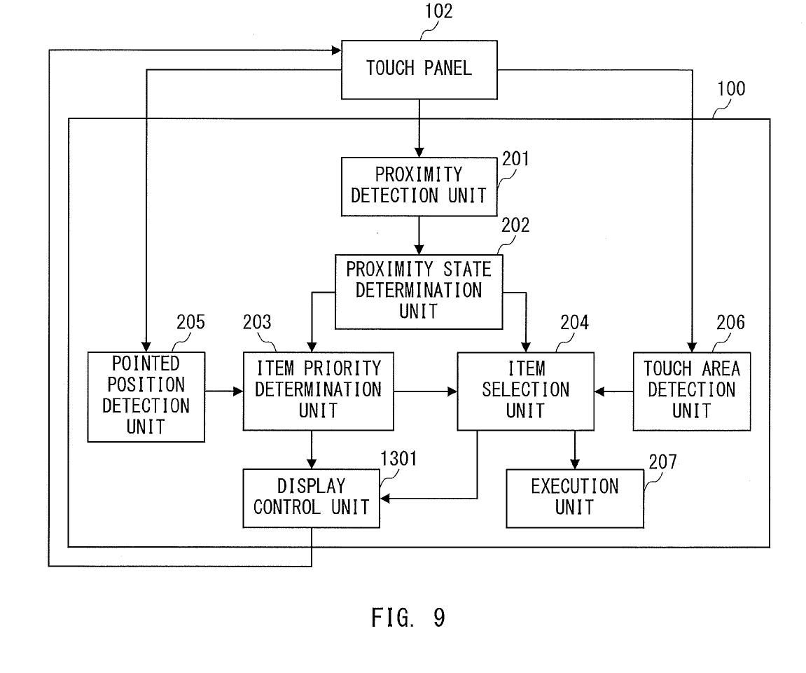

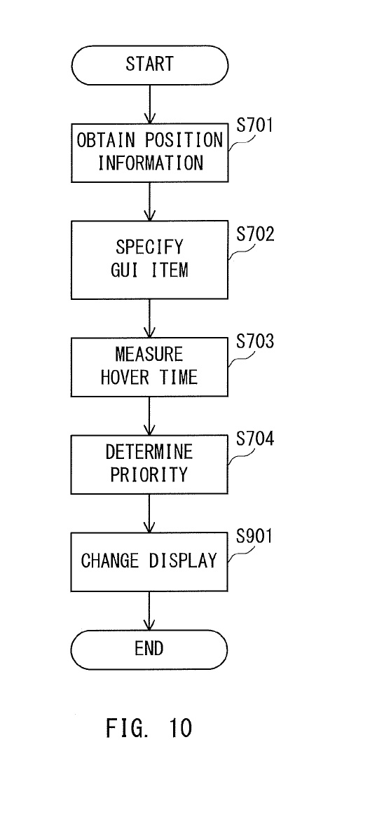

In the second embodiment, display mode of the GUI item displayed on the touch panel 102 is changed according to the priority. The hardware configuration of the information processing apparatus 100 of the second embodiment is similar to that of the first embodiment so that the description thereof is omitted. FIG. 9 is a functional block formed when the CPU 104 executes the computer program. In this functional block, display control unit 1301 is added, which is different from the functional block of the first embodiment in FIG. 2. Other than this, the both functional blocks are identically configured, therefore, description of the identical configuration is omitted. The display control unit 1301 changes the display mode of the GUI item included in the GUI screen based on the priority with reference to the management table.

FIG. 10 is a flowchart representing processing for determining the priority of the GUI item of the second embodiment including display control by the display control unit 1301. In this flowchart, the item priority determination unit 203 first performs the same processing as that of S701 to 704 in FIG. 7. Based on the priority determined in S704, the display control unit 1301 changes the display of the GUI item displayed on the touch panel 102 (S901).

For example, in the management table in FIG. 5, the priority is set to the buttons A, B, and C. Based on the priority, the display control unit 1301 changes a color of the button, thickness of frame line, blinking speed by a change in color and the like, the display control unit 1301 represents that the priority is set to the buttons A, B, and c. The display control unit 1301 may simply represent that the priority is set. In this case, the order of the priority may be represented by changing the representation according to the order of the priority.

This allows the user's touch operation of the GUI item having the priority set while confirming the change of its display mode. It is noted that the change of the display mode of the GUI item is returned to the original state when, for example, the management table is cleared.

### Third Embodiment

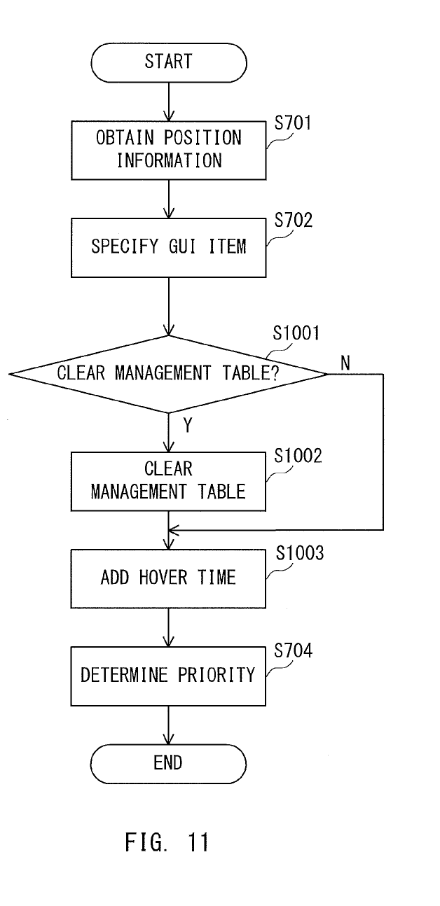

In the third embodiment, the hover state when determining the priority of the GUI item is restricted. The hardware configuration and the functional block of the information processing apparatus 100 of the third embodiment are similar to that of the first embodiment so that the description thereof is omitted. FIG. 11 is a flowchart representing processing for determining the priority of the GUI item of the third embodiment.

Similar to the first embodiment shown in FIG. 7, the item priority determination unit 203, having obtained the position information from the pointed position detection unit 205, specifies the GUI item (S701, S702). The item priority determination unit 203, after specifying the GUI item, determines whether to clear the management table or not (S1001). The item priority determination unit 203 determines whether to clear the management table or not using previous time, time when the hover time was last stored in the management table, and current time. If the difference between the previous time and the current time exceeds a predetermined time, the item priority determination unit 203 clears the management table. If it is within a predetermined time, the item priority determination unit 203 does not clear the management table. The item priority determination unit 203 stores the current time in the RAM 106 as the latest time at which the hover time is stored in the management table.

If it is determined to clear the management table (S1001: Y), the item priority determination unit 203 clears the management table (S1002) and adds the hover time (S1003). If it is determined not to clear the management table (S1001: N), the item priority determination unit 203 does not clear the management table and adds the hover time (S1003).

Thereafter, the item priority determination unit 203 determines the priority of the GUI item and ends the processing for determining the priority of the GUI item (S704).

As mentioned, if the time interval at which the hover time is stored exceeds a predetermined time, the item priority determination unit 203 determines the priority of the GUI item based on the latest hover time without using the past hover time. That is, when a predetermined time elapses after updating the priority of the management table, by clearing the management table, the item priority determination unit 203 sets the latest priority. Due to the above, it is prevented that the user's operation prior to a predetermined time influences the determination of the priority of the GUI item, which reduces the probability of the wrong operation.

In addition to restricting the hover time, a position pointed by the pointer may be restricted. For example, using the position of the GUI item pointed by the pointer which is initially stored in the management table as an initial position, the item priority determination unit 203 calculates the distance between the position represented by the position information obtained by the pointed position detection unit 205 and the initial position. If the distance calculated exceeds a predetermined distance, the item priority determination unit 203 clears the management table. If it is within the predetermined distance, the item priority determination unit 203 does not clear the management table. Due to the above, it is prevented that the operation to move more than a predetermined distance influences the determination of the priority of the GUI item, which reduces the probability of the wrong operation.

As mentioned, by controlling the hover time or position which is pointed by the pointer, even a case where the pointer moves a wide area in the hover state, according to the hover state near the position where is touch-operated, the priority of the GUI item can be determined. It is noted that, similar to the second embodiment, the display mode of the GUI item having the priority set may also be changed in the third embodiment.

### Fourth Embodiment

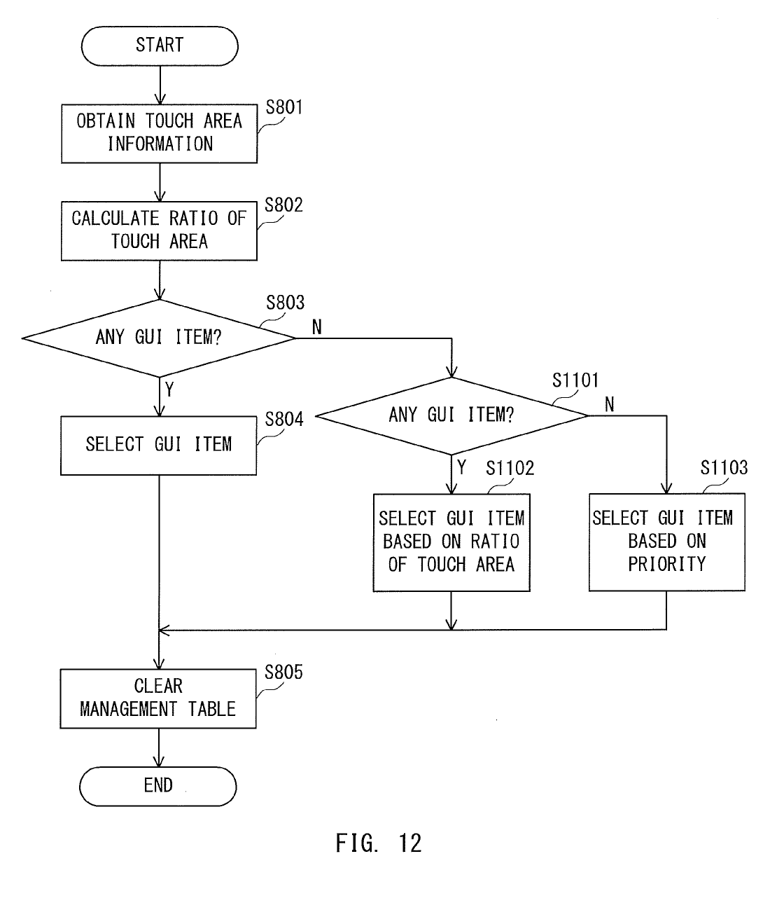

When selecting the GUI item, there may be a case where the GUI item having the priority set is not touched. Processing to cope with such situation is described in the fourth embodiment. The hardware configuration and the functional block of the information processing apparatus 100 of the fourth embodiment are similar to that of the first embodiment so that the description thereof is omitted. FIG. 12 is a flowchart representing processing for selecting the GUI item of the fourth embodiment.

Similar to the first embodiment shown in FIG. 8, the item selection unit 204 obtains the touch area information from the touch area detection unit 206 and calculates the ratio of the touch area. Then, the item selection unit 204 determines whether the GUI item having the priority set is in the touch area or not (S801, S802, S803). If it is determined that the GUI item to which the priority is set exists in the touch area (S803: Y), similar to the first embodiment shown in FIG. 8, the touch area detection unit 206 selects the GUI item and clears the management table (S804, S805).

If it is determined that the GUI item to which the priority is set is not in the touch area (S803: N), the item selection unit 204 determines whether or not the GUI item is in the touch area (S1101). If it is determined that the GUI item is in the touch area (S1101: Y), the item selection unit 204 confirms the ratio of the touch area of the GUI item in the touch area and, based on this, selects the GUI item (S1102). The item selection unit 204 selects the GUI item having the highest ratio of the touch area. If it is determined that the GUI item is not in the touch area (S1101: N), the item selection unit 204 selects the GUI item based on the priority (S1103). The item selection unit 204 selects the GUI item having the highest priority. The item selection unit 204 having selected the GUI item clears the management table and ends the processing (S805).

Through the above mentioned processing, if the GUI item having the priority set is not in the touch area, the GUI item is selected according to the ratio of the touch area. If the GUI item is not in the touch area, the GUI item is selected according to the priority.

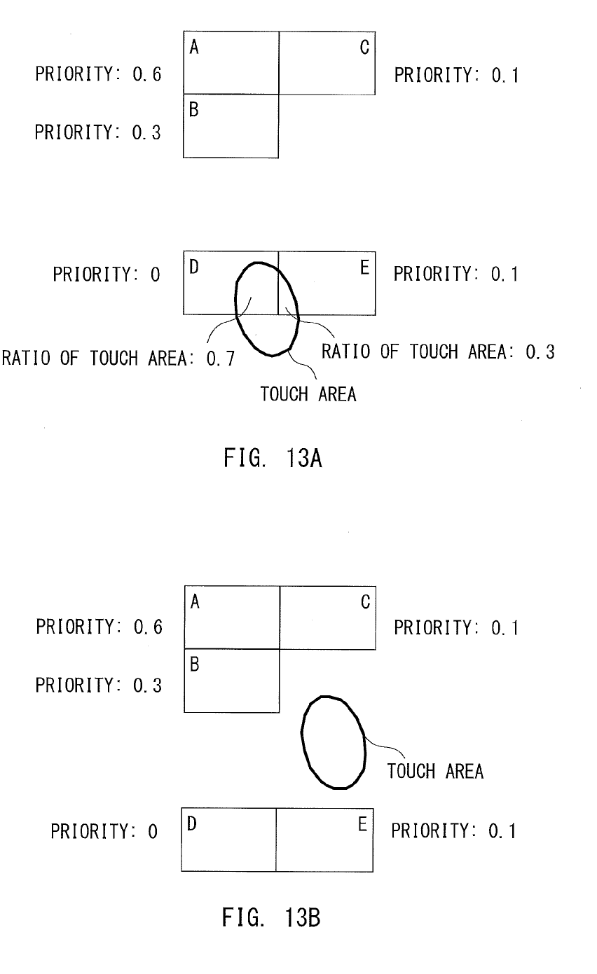

FIGS. 13A and 13B are diagrams explaining processing for selecting the GUI item. FIG. 13A represents a case where the GUI item having the priority set is not in the touch area. FIG. 13B represents a case where the GUI item is not in the touch area.

In FIG. 13A, the buttons A, B, and C, which are the GUI items having the priority set, are not in the touch area touched by the pointer. Instead, the buttons D and E, which are the GUI items to which no priority is set, are in the touch area. In this case, the item selection unit 204 selects the GUI item according to the ratio of the touch area. In FIG. 13A, the ratio of the touch area of the button D is “0.7” and that of the button E is “0.3”. Thereby, the item selection unit 204 selects the button D.

In FIG. 13B, the buttons A to E, which are the GUI items, are not in the touch area touched by the pointer. In this case, the item selection unit 204 selects the GUI item according to the priority. The priority of the buttons A, B, and C is “0.6”, “0.3”, and “0.1” respectively. Also, the priority of the buttons D and E is “0”. Thereby, the item selection unit 204 selects the button A.

Through the above mentioned processing, when the user wishes to select the GUI item to which no priority is set, the user can select the desired GUI item without performing the operation for clearing the priority. Thereby, the user's operation is simplified (FIG. 13A).

Further, when the desired GUI item is displayed at a position where is difficult to touch, the user confirms that high priority is set to the GUI item and touches the position where the GUI item is not displayed (FIG. 13B). Thereby, the user can select the correct GUI item even in a case where the display of the GUI item is small or other GUI item is adjacent to the GUI item. Due to this, the user can select the desired GUI item without any need to touch the position where is difficult to touch. It is noted that, as shown in FIG. 13B, if the position where the GUI item is not displayed is touched, the information processing apparatus 100 can end the processing without selecting the GUI item. In this case, user's usability is prioritized.

The fourth embodiment may be performed in combination with the second and the third embodiments. That is, after setting the priority of the GUI item as shown in the second and the third embodiments, the GUI item of the fourth embodiment may be selected.

Description has been given in a case where the touch panel 102 and the information processing apparatus 100 are integrated. Alternatively, the touch panel 102 may be provided separately from the information processing apparatus 100. For example, the same processing as the present embodiment can be realized in a configuration in which a display mounting the touch panel 102 is connected to a desktop PC. Further, processing may be performed by an external device. In this case, the execution unit 207 is not required. For example, the touch panel 102 is configured as an input device comprising the function of the controller 101 other than the execution unit 207. The touch panel 102 transmits the information relating to the GUI item selected to the external device to make the external device execute the processing.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-117872, filed Jun. 6, 2014 which is hereby incorporated by reference wherein in its entire embodiments of the present disclosure are described.

What is claimed is:

1. An information processing apparatus, comprising:
a display control unit configured to display a plurality of items on a display screen;
an identifying unit configured to identify a state of a pointer which is close to the display screen, whether the pointer is in a hover state or in a touch state;
a determining unit configured to determine priority of each of the plurality of items displayed on the display screen according to a duration pointed by the pointer which is in the hover state to the display screen; and
a specifying unit configured to specify the item touched by the pointer from the plurality of items displayed on the display screen using the priority determined by the determining unit in a case where the state of the pointer identified by the identifying unit is changed from the hover state to the touch state.

2. The information processing apparatus according to claim 1, wherein each of the plurality of items corresponds to processing which is executable in the information processing apparatus, further comprising:
an execution unit configured to execute processing which corresponds to the item specified by the specifying unit.

3. The information processing apparatus according to claim 1, further comprising:
a position detection unit configured to detect, in a case where the pointer is close to the display screen on which the plurality of items are displayed, a position pointed by the pointer; and
wherein the determining unit is further configured to set the priority to the item displayed at the position detected by the position detection unit or the item displayed at a position at which correction value is added to the position detected by the position detection unit.

4. The information processing apparatus according to claim 1, wherein:
the determining unit is further configured to set higher priority to each of the plurality of items having a longer duration pointed by the pointer which is in the hover state; and
the specifying unit is further configured to specify the item selected from the plurality of items according to a position at which the pointer touched the display screen and the priority.

5. The information processing apparatus according to claim 1,
wherein the determining unit is further configured to set the priority to an object according to the duration pointed by the pointer and a history of the object selected in past.

6. The information processing apparatus according to claim 1,
further comprising a display control unit configured such that a display mode of the item having the priority set by the determination unit differs from the display mode of the item prior to setting the priority.

7. The information processing apparatus according to claim 1,
wherein the determination unit is configured to clear the priority after a lapse of a predetermined time after setting the priority.

8. The information processing apparatus according to claim 1,
wherein the determination unit is further configured to clear the priority if the position pointed by the pointer moves more than a predetermined distance from a display position of the item having the priority initially set.

9. The information processing apparatus according to claim 1, further comprising a touch area detection unit configured to detect a touch area at which the pointer touched the display screen,
wherein the specifying unit is further configured to specify the item according to a size of the display area of the item included in the touch area detected by the touch area detection unit and the priority.

10. The information processing apparatus according to claim 9,
wherein the specifying unit is further configured to select, in a case where the display area of the item having the priority set is not included in the touch area, if one or more display areas of the item to which no priority is set are included in the touch area, the object according to the size of the display area of the item to which no priority is set included in the touch area.

11. The information processing apparatus according to claim 10,
wherein the specifying unit is further configured to select the item according to the priority in a case where the display area of the item is not included in the touch area.

12. The information processing apparatus according to claim 1,
wherein the hover state is a state in which the pointer is within a predetermined distance from the display screen and the pointer does not touch the display screen.

13. An input method executed by an information processing apparatus having a display screen on which a plurality of items are displayed, comprising:
identifying a state of a pointer which is close to the display screen, whether it is in a hover state or in a touch state;
determining priority of each of the plurality of items displayed on the display screen according to duration pointed by the pointer which is in the hover state to the display screen;
specifying the item touched by the pointer from the plurality of items displayed on the display screen based on the priority in a case where the state of the pointer is changed from the hover state to the touch state.

14. A computer readable recording medium containing computer program for causing a computer comprising a display screen on which a plurality of items are displayed to function as:
an identifying unit configured to identify a state of a pointer which is close to the display screen, whether it is in a hover state or in a touch state;
a determining unit configured to determine priority of each of the plurality of items displayed on the display screen according to duration pointed by the pointer which is in the hover state to the display screen; and
a specifying unit configured to specify the item touched by the pointer from the plurality of items displayed on the display screen based on the priority determined by the determining unit in a case where the state of the pointer identified by the identifying unit is changed from the hover state to the touch state.
